(19) United States
(12) Patent Application Publication
(10) Pub. No.: US 2007/0013931 A1
(43) Pub. Date: Jan. 18, 2007

(54) Source document management method, print control apparatus, and print control program

(75) Inventor: Atsushi Ito, Yawata-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/237,898

(22) Filed: Sep. 29, 2005

(30) Foreign Application Priority Data
Jul. 15, 2005 (JP) 2005-206971

(51) Int. Cl. G06F 3/12

(52) U.S. Cl. 358/1.13; 358/1.15

(57) ABSTRACT

Print sequence of a document in a print source document having a plurality of the documents is set in a job ticket. While, with respect to the each document, print attribute of the document is set separately from the job ticket in a non-link state with the print sequence. Then, the print sequence and the print attribute are obtained to generate print control data which enables a printing apparatus to print according to the print attribute and print sequence. Consequently, even when a source document configuration is changed, a user can perform desired print.

This application is based on an application No. 2005-206971 filed on Jul. 15, 2005 in Japan, the contents of which is hereby incorporated by reference.

### BACKGROUND OF THE INVENTION

1. Field of the Invention

The present invention relates to a source document management method, a print control apparatus, and a print control program.

2. Description of the Related Art

Conventionally, in a plurality of record papers, that is, in a source document made of documents of a plurality of pages, for example, in a case that a sheet which differs from sheets of other pages is desired to be used for a specific paper when printing output to papers, the above-mentioned specific page is designated on a printer driver.

Further, the patent document 1, Japanese Unexamined Patent Application Publication No. 2003-280871 discloses technology that designation data including different output condition in each page are made and a print job including the designation data is generated in order to easily and rapidly perform print output of one source document in which pages having different output conditions are mixed.

In addition, the patent document 2, Japanese Unexamined Patent Application Publication No. 2004-126871 discloses technology which allows a whole setting applied to the whole on one print job and a partial setting designated on every page for the print job in order to permit a print setting in every page and stores the whole and partial settings in a setting table.

However, in the case that a type of paper on a specific page is designated as described above, when a document order in a source document is changed from a previous one due to source document edition or the like, a new page number after change needs to be renumbered again. That is, in conventional technology, when a source document is made of documents of a plurality of pages, page order information in the source document is linked to print conditions information of each record paper in printing output. More specifically, for example, one source document is composed of 4 pages defining that a first page is printed in a white background paper; a second page, in a red background paper; a third page and a fourth page, in white background papers. After that, in the case that a new second page to be printed in a blue background paper is added between the first page and the second page due to a source document edition, newly changed page numbers need to be renumbered again so that the first page is printed in the white background paper; a new second page, in the blue background paper; a new third page being the previous second page, in the red background paper; a new fourth page being the previous third page, in the white background paper; a new fifth page being the previous fourth page, in the white background paper.

Although the above-mentioned patent documents 1 and the patent document 2 disclose technology that print conditions are varied on every page to output, the technology allows setting of output condition of each page in the source document of fixed page numbers to output, that is, to perform printing based on the setting. Namely, document information constituting pages, print conditions with respect to the document information of the pages, and page numbers of the pages are linked with each other. Consequently, there is a problem in that, when editing or the like is added to change a configuration of the source document, for example, when page order is changed, the previous setting makes no sense, thus, a page necessary for setting of print conditions needs to be reset as in the example of the above-mention. Therefore, there arises a problem in that misprinting is likely induced.

Further, for example, in the case that a source document is composed of 4 pages designating that a first page is printed in a thick paper; a second to a fourth page are printed in plain papers, for example, when “2 in 1” is designated, that is, for 2 pages are printed in one piece of sheet, the first page and the second page are printed in one piece of thick paper; the third page and the fourth page are printed in one piece of plain paper regardless that the second page is conventionally printed in the plain paper.

### SUMMARY OF THE INVENTION

The present invention has been made to solve the aforementioned problems, and an object of the present invention is to provide a source document management method which allows users to perform desired printing even when a source document configuration changes due to a source document editing or the like, a print control apparatus for implementing the source document management method, and a print control program.

To attain the aforementioned object, the present invention is configured as described below.

That is, according to a first aspect of the present invention, there is provided a source document management method for managing a print source document having a plurality of source document configuration parts, the method comprising:

setting a print sequence of each of the source document configuration parts in the print source document to a job ticket; and

with respect to each of the source document configuration parts, setting a print attribute of the source document configuration part separately from the job ticket.

Further, the source document management method may be designed so that the method further comprises, after obtaining the print sequence of the source document configuration part and each print attribute, generating print control data, which enables a printing apparatus to print each of the source document configuration parts in accordance with the print attribute and the print sequence, when the print source document is printed.

Further, the source document management method may be designed so that the method further comprises, when generating the print control data, selecting the source document configuration part set in the job ticket and disposed with the print sequence on a basis of a name of the source document configuration part, extracting the print attribute set in the selected source document configuration part, and making the print sequence and the extracted print attribute correspond to each other.

Further, the source document management method may be designed so that the method further comprises, before printing, displaying a print preview of the source document configuration part on a basis of the generated print control data.

Further, the source document management method may be designed so that the method further comprises, when generating the print control data, forming a non-print part in the print source document according to the print attribute and the print sequence in the source document configuration part.

Further, the source document management method may be designed so that the setting of the print attribute with respect to the source document configuration part is performed in a state irrelevant to the print sequence.

Moreover, according to a second aspect of the present invention, there is provided a print control apparatus for controlling print operation of a print source document having a plurality of source document configuration parts, the apparatus comprising:

a job ticket storage section configured to store a job ticket having a print sequence of each of the source document configuration parts;

a print attribute storage section configured to store a print attribute to be set with respect to each of the source document configuration parts; and

a print control data generation section configured to obtain the print sequence and the print attribute of the source document configuration part, and generate print control data which enables a printing apparatus to print the each source document configuration part according to the print attribute and the print sequence.

Furthermore, according to a third aspect of the present invention, there is provided a print control program for printing a print source document having a plurality of source document configuration parts, the program making a printing apparatus execute and comprising:

setting a print sequence of each of the source document configuration parts in the print source document to a job ticket;

setting a print attribute of the source document configuration part with respect to the each of the source document configuration parts separately from the job ticket;

obtaining the print sequence and the print attribute of the source document configuration part; and

generating print control data which enables the printing apparatus to print each source document configuration part according to the print attribute and the print sequence.

According to the source document management method of the first aspect, the print control apparatus of the second aspect, and the print control program of the third aspect of the present invention, a user need not to reset the print attribute to the source document configuration part again depending on a new print sequence even when the source document configuration changes due to source document editing or the like, and it becomes possible to perform the user's desired print, that is, to print the source document configuration part by the designated print attribute in a print sequence of the source document configuration part.

### BRIEF DESCRIPTION OF THE DRAWINGS

FIG. 1 is a block diagram showing a configuration of a print control apparatus according to an embodiment of the present invention;

FIG. 2 is a view showing an example of a dialog for setting a print attribute by a print attribute setting section shown in FIG. 1;

FIG. 3 is a view showing an example of a dialog when a page unit setting is selected by the dialog shown in FIG. 2;

FIG. 4 is a view showing an example of a dialog when a list display is selected by the dialog shown in FIG. 3;

FIG. 5 is a view showing an example of a dialog when a print attribute set by a print attribute setting section shown in FIG. 1 is changed;

FIG. 6 is a view showing a configuration of a job ticket stored in a job ticket storage section shown in FIG. 1;

FIG. 7 is a view showing an example of a dialog for performing a print setting with respect to a whole print source document print-controlled by a print control apparatus shown in FIG. 1;

FIG. 8 is an example of a print preview image displayed in a GUI display section shown in FIG. 1;

FIG. 9 is a view showing an example of a dialog displayed in a print information display section shown in FIG. 1;

FIG. 10 is a view for explaining a relationship among a print source document print-controlled by the print control apparatus shown in FIG. 1, the job ticket, and page information database shown in FIG. 6;

FIG. 11 is an example of a print control command included in print control data generated by a print control data generation section shown in FIG. 1;

FIG. 12 is an example of the print preview image displayed in the GUI display section shown in FIG. 1;

FIG. 13 is a view showing an example of the print attribute in each document which constitutes the print source document print-controlled by the print control apparatus shown in FIG. 1;

FIG. 14 is a view showing an example of the print attribute with respect to the whole print source document print-controlled by the print control apparatus shown in FIG. 1;

FIG. 15 is a flow chart showing generation operation of print control data by the print control data generation section shown in FIG. 1;

FIG. 16 is a flow chart showing operation of step S104 shown in FIG. 15;

FIG. 17 is an example of an array in which the print attribute of the document in the print source document print-controlled by the print control apparatus shown in FIG. 1 is held;

FIG. 18 is an example of the print preview image displayed in the GUI display section shown in FIG. 1;

FIG. 19 is a view for explaining a relationship between image data processed by the print control apparatus shown in FIG. 1 and the print attribute; and

FIG. 20 is a flow chart for explaining print control operation implemented by the print control apparatus shown in FIG. 1.

### DESCRIPTION OF THE PREFERRED EMBODIMENTS

A source document management method, a print control apparatus for executing the source document management method, and a print control program executed by the print control apparatus, which are embodiments of the present invention, will be described below with reference to the drawings. In addition, the same reference numerals are given to the same configuration portions in respective drawings.

Further, a “source document configuration part” corresponds to a “document” or corresponds to an identifiable image data part depending on a name or the like, and more specifically, for example, corresponds to a printed part in one record sheet. In addition, it may be written as a “page” in the drawing. Further, one having a plurality of “documents” is written as a “print source document” below.

The print control apparatus will be described. In the print control apparatus, the print source document is controlled in a unit of the source document configuration part, that is, in a unit of the document; and application software, which performs print by combining the documents to form the print source document, is used. Consequently, the print control apparatus will be described below in such a way that function of the each configuration portion included in the print control apparatus will be described; and such description may also explain the source document management method, which is performed by the application software executed by the print control apparatus, and the print control program in the application software.

Further, the print control apparatus may be constituted by a personal computer.

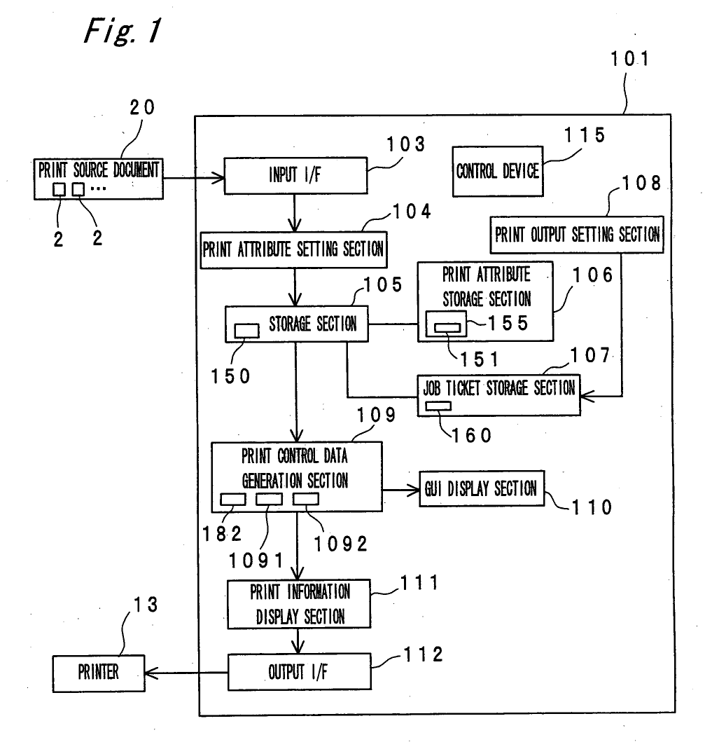

FIG. 1 shows a basic component of a print control apparatus 101. The print control apparatus 101 has an input I/F 103, a print attribute setting section 104, a storage section 105, a print attribute storage section 106, a job ticket storage section 107, a print output setting section 108, a print control data generation section 109, a GUI display section 110, a print information display section 111, an output I/F 112, and a control device 115 which performs operation control of these configuration portions, specifically, CPU (central processing unit). Of these configuration portions; those particularly important from the stand points of print control and source document management method are the print attribute storage section 106, the job ticket storage section 107, and the print control data generation section 109.

First, general description of the print control apparatus 101 will be described and a part of it will be described in detail later.

A document 2 corresponding to the source document configuration part or a print source document 20 is supplied to the input I/F 103. In addition, here, the document 2 supplied to the input I/F 103 is formed by image data including not only characters but also pictures; and there is a case that the document is directly supplied via communication wire or obtained by scanning a record sheet with a scanner. Since the following description takes an example in the case that there is a plurality of record sheets, it becomes that data of the print source document 20 is supplied to the input I/F 103.

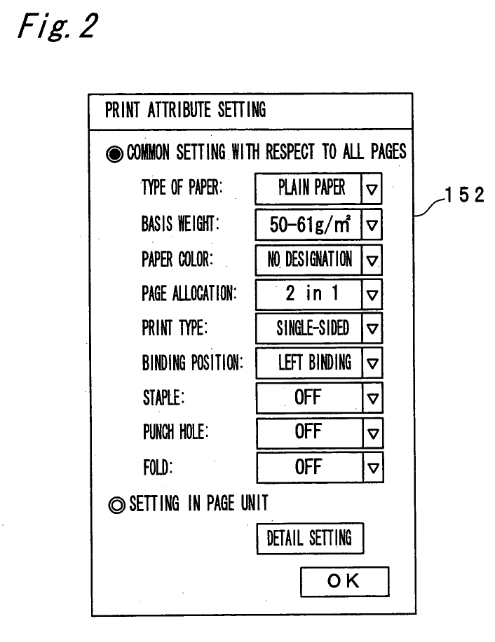

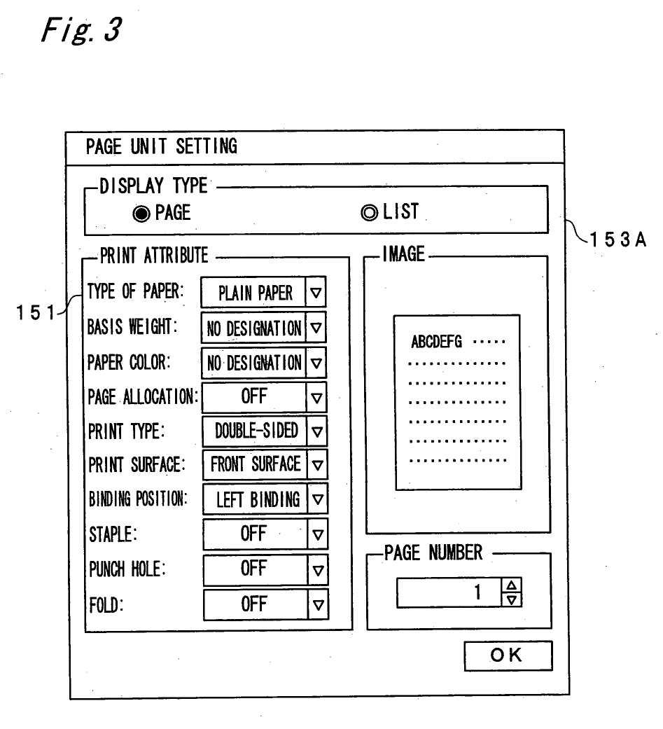

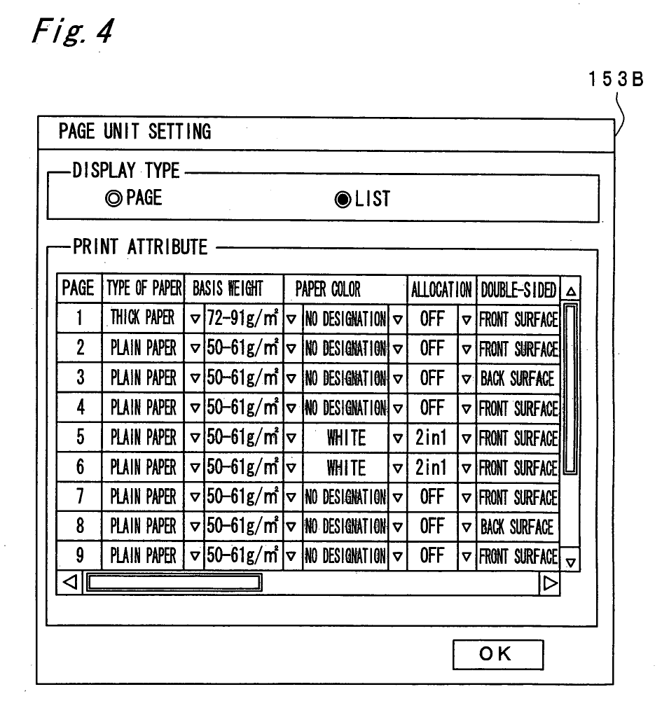

The print attribute setting section 104 prompts a user to set a print attribute of the each document 2 constituting the print source document 20 with respect to the supplied print source document 20. Further, GUI (Graphical User Interface) image displays (FIG. 2 to FIG. 5) for setting the print attribute are displayed in the display section 110. Here, as shown in FIG. 2 and FIG. 3, the print attribute 151 denotes information indicating an attribute in the document 2, that is, image data which is given by name or the like and can be distinguished from another; and more specifically, attribute element information such as a type of paper, basis weight, paper color, and the like. In addition, in the following description, a term of the print attribute 151 is used for both cases, in the case of indicating each of the attribute elements such as the type of paper, basis weight, and paper color and in the case of generically naming the attribute element. As shown in FIG. 2, a setting dialog 152 of the print attribute 151 has function which selects either setting of all the documents 2 of the registered print source document 20 by the same print attribute 151, or individual setting of the each document 2. Here, when an “OK” button is depressed by selecting a “common setting with respect to all pages,” setting values set on the dialog 152 is set with respect to all the documents 2 in the print source document 20. On the other hand, a “detail setting” button is pushed by selecting a “setting in page unit” with the setting dialog 152, page unit setting dialog 153A and 153B are displayed as shown in FIG. 3 and FIG. 4. Both displays are exclusive and therefore displayed by change-over with a “display type.”

When a “page” is selected by the “display type” in the page unit setting dialog 153A shown in FIG. 3, the print attribute 151 can be set by designating any document 2 with a “page number” while image of the designated document 2 is displayed. On the other hand, when a “list” is selected by the “display type” in the page unit setting dialog 153B shown in FIG. 4, setting can be made while referring settings of other documents 2 because all documents 2 of the print source document 20 are displayed in a list.

In either screen, when the “OK” button is depressed, setting of the print attribute 151 with respect to the each document 2 at that time becomes effective.

In addition, reference numeral “1” of the “page number” shown in FIG. 3 and reference numerals “1,” “2,” . . . , and “9” of the “page” column shown in FIG. 4 denote information corresponding to name or the like for specifying the each document 2, that is, it does not denote information indicating the print sequence.

As is clear from the aforementioned description, when the print attribute 151 is set with respect to the each document 2, information related to the print sequence of the each document 2 when printing the print source document 20 is not set at all. In other words, the print attribute 151 with respect to the each document 2 is not linked to the print sequence of the each document 2 when printing the print source document 20, but is set in a non-link state. That is, the print attribute 151 is a state which does not relate to the print sequence, that is, the print attribute 151 is not controlled by the print sequence.

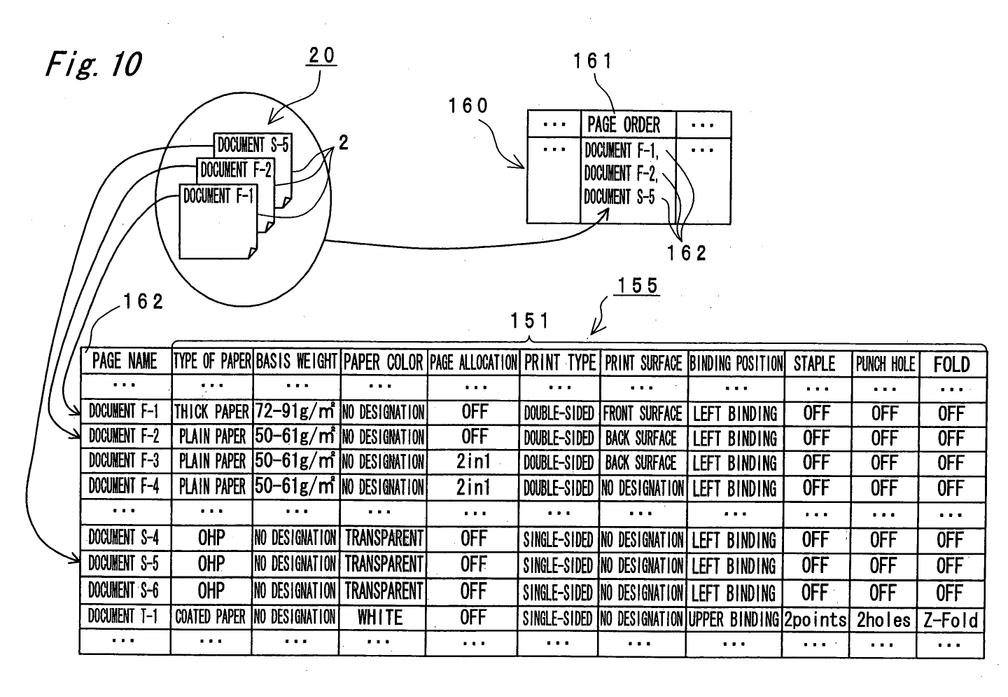

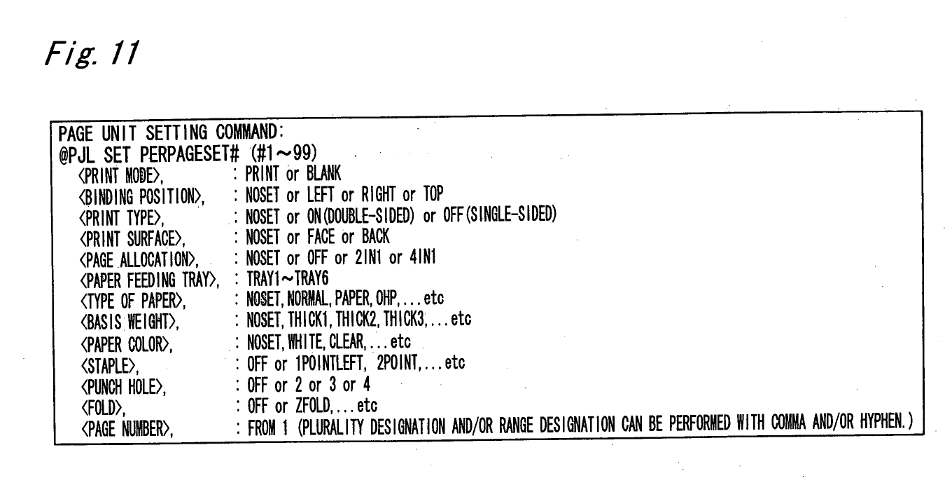

The set print attribute 151 is not related to the print sequence, but is related to image data 150 of the each document 2. In this embodiment, the image data 150 is stored in the storage section 105 and the print attribute 151 is stored in the print attribute storage section 106. Further, in this embodiment, the print attribute 151 is stored in the print attribute storage section 106 as a page information database 155 shown in FIG. 10. The print attribute storage section 106 is another area other than a storage section 150 which stores the image data 150 of the each document 2, but it is not limited to this embodiment. That is, as shown in FIG. 19, as for the each document 2, the image data 150 and the print attribute 151 related to the image data 150 may be stored in the storage section 105 as a source document configuration part with a print attribute 181. Further, it is not necessary to stick to the source document configuration part with a print attribute 181 which combines the image data 150 with the print attribute 151; those having another setting file for the print attribute 151 may be stored in the same place as the image data 150, for example, in the storage section 105.

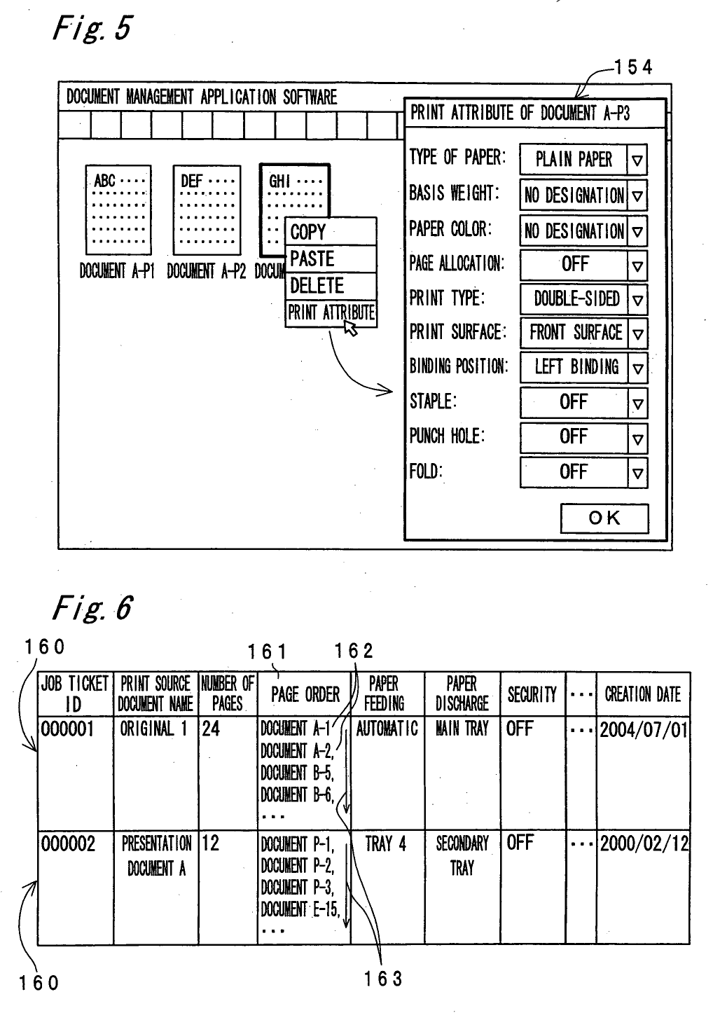

Setting of the print attribute 151 to the document 2 is not limited to the time at which the document 2 or the print source document 20 is registered; a configuration portion, which performs change of the aforementioned setting at any timing, maybe provided. For example, as shown in FIG. 5, any document 2 is selected and a page unit setting dialog 154 for setting the print attribute 151 of the selected document 2 may be displayed.

The print control apparatus 101 and the source document management method executed by the print control apparatus 101 are configured to form the print source document 20 by combining with any document 2. Information that which document 2 is disposed in what order in the print source document 20 and information that how print output process is performed on the print source document 20, are stored in a job ticket 160 having a configuration as shown in FIG. 6, for example, to manage. One job ticket 160 constitutes one print source document 20. These job tickets 160 are stored in the job ticket storage section 107.

In this embodiment, as shown in FIG. 6, a “page order” column 161 included in the job ticket 160 has only information of page name 162 for specifying the document 2, such as merely a “document A-1” and a “document P-1.” That is, for example, the image data 150 corresponding to the document 2 specified by the name of the “document A-1” and, further information of the print attribute 151 set in the document 2 specified by the name of the “document A-1” are not included in the page order column 161. Then, the page order column 161 is a portion for designating the print sequence of the each document 2 which constitutes one print source document 20. When the case of FIG. 6 is taken for instance, for example, according to the job ticket 160 in which a job ticket ID is “000001”, as for the print source document 20 named by an “original 1,” printing of the each document 2 is performed in the order of “document A-1” →“document A-2”→“document B-5”→“document B-6”→. . . . Here, when description of the page order column 161 is changed from the top to the bottom, for example, “document A-1,” “document B-6,” “document B-5,” and “document A-2,” as for the print source document 20 named by the “original 1,” printing of the each document 2 is performed in the order of “document A-1”→“document B-6”→“document B-5”→“document A-2”→. . . . As described above, the print sequence of the each document 2 when printing the print source document 20 is set by the page order column 161 of the job ticket 160. Afterward, a reference numeral 163 is given to the print sequence of the each document 2 set by the page order column 161.

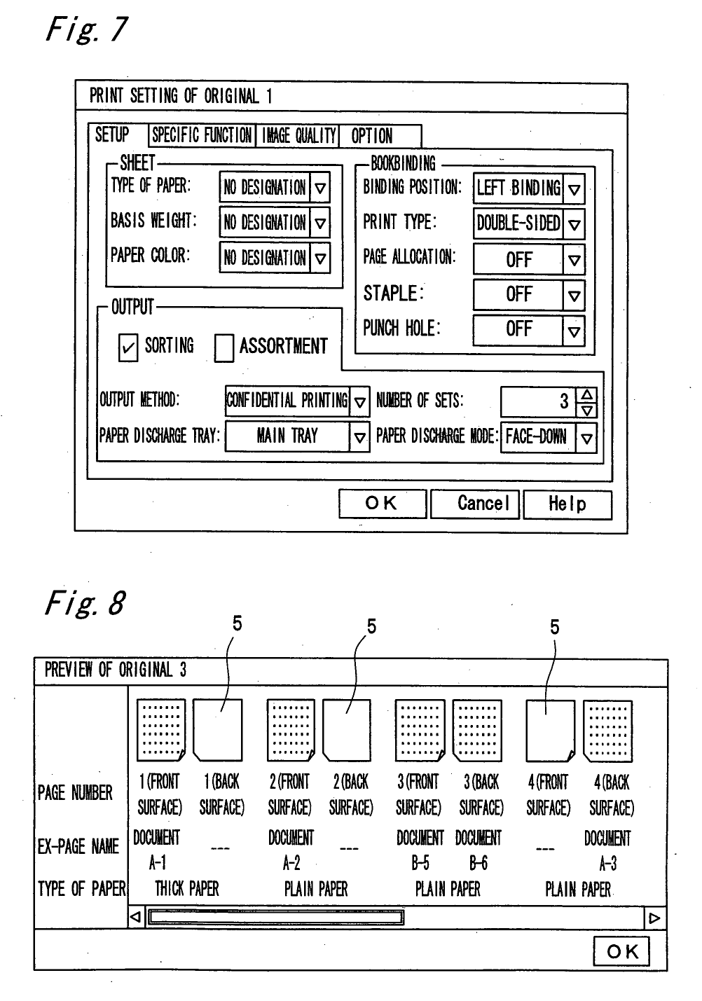

Setting of print with respect to the whole print source document 20 is performed by the print output setting section 108. For example, the print source document 20 named by the “original 1” is taken to show an example of its print setting screen on FIG. 7.

Setting here, for example, as in the case that a password is given to the print source document 20 and the print source document 20 is printed like a confidential printing, is a setting to be effective in a unit of theprint source document 20. In this regard, function capable of setting as the print attribute 151 of the each document 2, for example, as in the designation of both sides for a print type, may be set by overlapping for the document 2. In this case, setting parameters in the print attribute 151 of the document 2 are set as setting parameters having priority over the print attribute setting with respect to the whole print source document 20 and selection that setting of the print attribute 151 has priority may be made. Further, contrary, in the case of overlapping the print attribute 151 with contents of print setting of FIG. 7, selection may be made that the print attribute 151 is ineffective and the contents of the print setting is effective.

As described above, in this embodiment, the print sequence 163 of the each document 2 is set by the job ticket 160; further, since the print sequence 163 is not linked with the image data 150 and the print attribute 151, there is a case that a user wants to confirm how the each document 2 in the print source document 20 is actually printed by the printer 13 on a screen. Therefore, a print preview of the print source document 20 is displayed on the display section 110. Function of the print preview is provided in the GUI display section 110. When the preview function is designated by a user, the print control data generation section 109 analyzes the print attribute 151 in all the documents 2 in the print source document 20 and print output process setting stored in the job ticket 160 to generate print control data 182 necessary for executing print.

As an example of the print output process setting, output processing of the print sequence 163 of the each document 2 in the print source document 20, and the image data 150 and the print attribute 151 in these documents 2 is taken as the example. The output processing will be specifically described.

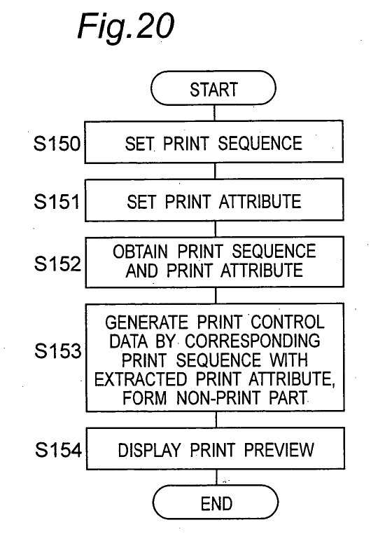

Outline of the above-mentioned output processing, that is, print control operation of the print source document 20 with respect to the printer 13 will be shown in FIG. 20. First in step S150, as described above, the print sequence 163 of the each document 2 is set in the job ticket 160; in step S151, as described above, the print attribute 151 of the each document 2 is set and stored in the print attribute storage section 106. In addition, executing sequence of step S150 and step S151 is irrelevant. In the next step S152, the print sequence 163 of the each document 2 is obtained from the job ticket 160, and the print attribute 151 of the each document 2 is obtained from the print attribute storage section 106. In the next step S153, the print control data 182 which enables the print source document 20 to be printed by the printing apparatus 13 according to the obtained print sequence 163 and the print attribute 151. Then, in the next step S154, a print preview of the document 2 and the print source document 20 can be displayed. Each operation will be described below in detail.

The print control data generation section 109 obtains information of the print sequence 163 stored in the page order column 161 of the job ticket 160 shown in FIG. 6 and confirms the name 162 of the each document 2. Then, the print control data generation section 109 extracts the print attribute 151 of the each document 2 based on the page name 162 by using the page information database 155 shown in FIG. 10, which stores the page name 162 and the print attribute 151 in a linked state. As a result, the print control data generation section 109 links the print sequence 163 of the each document 2 to the image data 150 and the print attribute 151. In this way, correspondence of the print sequence 163 of the each document 2 to the image data 150 and the print attribute 151 in the print control data 182 is prepared.

As described above, the print control data generation section 109 analyzes the print attribute 151 in all the documents 2 in the print source document 20 and the print output process setting stored in the job ticket 160 and forms the print control data 182. Consequently, a user need not to reset the print attribute 151 to the each document 2 again depending on a new print sequence even when configuration of the print source document 20 changes due to editing work or the like, and further it becomes possible to perform the user's desired print, that is, to print the each document 2 by the designated print attribute 151 in the print sequence of the each document 2.

The GUI display section 110 analyzes the print output process setting in the job ticket 160 and the print control data 182 generated by the print control data generation section 109 to perform image display by simulating the output result of the printer 13. An example of the image display will be shown in FIG. 8.

In the example of FIG. 8, a first document 2 (document A-1) and a second document 2 (document A-2), both documents constituting the print source document 20, are set by different a type of papers, that is, the document A-1 is set by “thick paper” and the document A-2 is set by “plain paper.” In such a case, if the second document A-2 is printed on a back surface of the first document A-l, the print attribute 151 of the document A-2 is neglected. Thus, the document A-2 is not printed on the back surface of the document A-1, but it is printed as a front surface of the second document A-2. In the print preview, control on the side of the printer 13 is simulated prior to display a preview image; when the printer 13 automatically feeds a blank sheet, the preview image is also displayed in a state that the blank sheet is fed. In the example of FIG. 8, a back surface of a page number 1, a back surface of a page number 2, and a front surface of page number 4 of the print source document 20 correspond to the blank sheet.

As described above, the image data 150 and the print attribute 151 in the document 2 is differently set from the print sequence 163 of the document 2 and the print control data generation section 109 analyzes the print attribute 151 in all the documents 2 in the print source document 20 and the print output process setting stored in the job ticket 160 to generate the print control data 182, whereby an addition of such blank sheet, that is, a non-print part 5 can be achieved.

Condition that blank sheet is fed as described above also depends on the printer 13. For example, there are cases that double-sided printing, a type of paper, basis weight, and paper color are different between before and after documents 2; a back surface is designated as a print surface by the print attribute 151; and page allocation is set to be different between before and after documents 2.

In addition, a user does not necessarily execute the preview function prior to performing print, but can perform print immediately. At this time, the GUI display section 110 does not function, but the print control data generation section 109 functions in order to perform print; the print control data 182 generated is integrated into one together with the image data 150 of the each document 2.

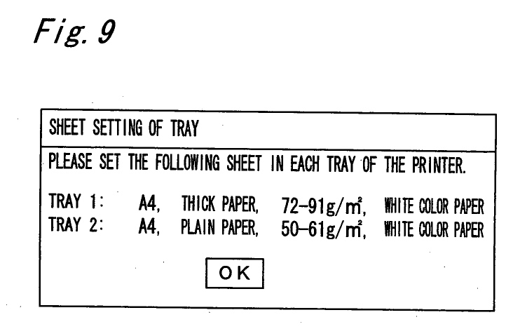

The print information display section 111 displays a message for giving a user information necessary for performing print. Here, the printer 13 serves to inform a user of necessary setting at the printer according to the print attribute 151 of the each document 2. For example, when the document 2 having the print attribute 151, such as “thick paper” and “plain paper,” is included in the print source document 20; the print information display section displays a message such as “set ‘thick paper’ in the tray 1 and ‘plain paper’ in the tray 2” shown in FIG. 9, for instance.

This makes a user set sheets displayed in the print information display section 111 to the printer 13; further, according to need, the user needs to set a type of paper, basis weight, and paper color of the each tray at the printer 13.

When a user depresses the “OK” button in a message display of the print information display section 111, the print control data 182 is transmitted to the printer 13 via the output I/F 112.

Here, for example, an information communication system, which can perform a tray setting on the printer 13 side, for example, such as a setting of a type of paper from the print control apparatus 101 side, is introduced between the print control apparatus 101 and the printer 13 for performing print; then, as depressing of the “OK” button, setting information of the type of paper, basis weight, paper color for each tray are transmitted to the printer 13 side in advance to the print control data 182, whereby it may provide a mechanism which completes setting without user's help.

The printer 13 performs processing of the print source document 20 according to the print control data 182 received to perform print and paper discharge. In this regard, according to the print output process setting, print is not performed on actual paper, but there is a case to be stored in a storage device such as a hard disk device or the like provided with the printer 13.

Now, the aforementioned content will be described from the stand point of generating a print control command included in the print control data 182. In addition, as described above, since the print control data 182 is formed by the print control data generation section 109, generating operation of the print control command to be described below is also executed by the print control data generation section 109.

As described above, the page names 162 of the all documents 2 which constitute the print source document 20 and the print sequence 163 of the page name 162 are stored in the job ticket 160 as information. Further, information of the print attribute 151 in the each document 2 is stored in the page information database 155.

In the print control data generation section 109, information of the page order column 161 is obtained first from in the job ticket 160; and, from information of the page name 162 included in the page order column 161, the print attribute 151 of the each document 2 is obtained from the page information database 155.

Next, the print attributes 151 of the all documents 2 are retrieved and the print control data 182 is generated according to those print attributes 151 so that the printer 13 can perform print. At this time, there is the same print attributes 151 in a plurality of the documents 2 and when the control data can be optimized as a whole, the print control data generation section 109 determines the optimization. For example, the page information database 155 shown in FIG. 10 is referred as an example, and regarding the example, a data generation process will be described below.

In the print source document 20 having three documents 2 whose page names 162 are “document F-1,” “document F-2,” and “document S-5,” as is clear from the page information database 155 shown in FIG. 10, the print attributes 151 of the all documents 2 are different. Consequently, generation of the print control data 182 will be started in order from the first document 2 (document F-1). When a print control command of a specification as shown in FIG. 11 which can change a paper feeding tray every document 2 is used, a following print control command is generated from setting values of the type of paper, basis weight, paper color, and the like.

@PJL SET PERPAGESET1=PRINT,LEFT,ON,FACE,OFF,TRAY1,PAPER,THICK2,NOSET,OFF,OFF,OFF,1

Next, processing ismoved to the second document 2 (document F-2). The second document 2 needs to be printed on a sheet of plain paper with 50 to 61 g/m². Consequently, although the first document 2 and the second document 2 are set to “double-sided printing,” if the second document 2 is printed on the back surface of the record sheet in which the first document 2 is printed, the print attribute of the second document 2 is neglected. Therefore, it is not possible to print the second document 2 on the back surface of the record sheet in which the first document 2 is printed. Further, in the second document 2, the print attribute 151, in which the second document 2 is printed on the back surface of the double-sided printing, is set. Consequently, blank sheet, that is, the non-print part 5 needs to be formed on the front surface of the record sheet in which the second document 2 is printed. Therefore, the print control command for feeding blank sheet is added in addition to control data for printing the document 2 in order to print the second document 2 according to the print attribute 151; thus, the following print control command is generated.

@PJL SET PERPAGESET2=BLANK,LEFT,ON,FACE,OFF,TRAY2,NOSET,NOSET,NOSET,OFF,OFF,OFF,2

@PJL SET PERPAGESET3=PRINT,LEFT,ON,BACK,OFF,TRAY2,PAPER,NORMAL,NOSET,OFF,OFF,OFF,2

In addition, here, the print control command is used to feed the blank sheet, however, in the print control program of this embodiment, it is possible to achieve the same result by a method in which a document 2 of actual blank sheet, that is, a document 2 with nonexistent image data 150 is generated and is inserted between the first and the second documents 2. Further, according to a printer 13, there is one which automatically feed blank sheet on the printer side.

In a similar way, the following print control data is also generated in the third document 2.

@PJL SET PERPAGESET4=PRINT,LEFT,OFF,NOSET,OFF,TRAY3,OHP,NOSET,CLEAR,OFF,OFF,OFF,3

The thus-generated print control data 182 is added to the image data 150 of the each document 2 when performing print to be transmitted to the printer 13.

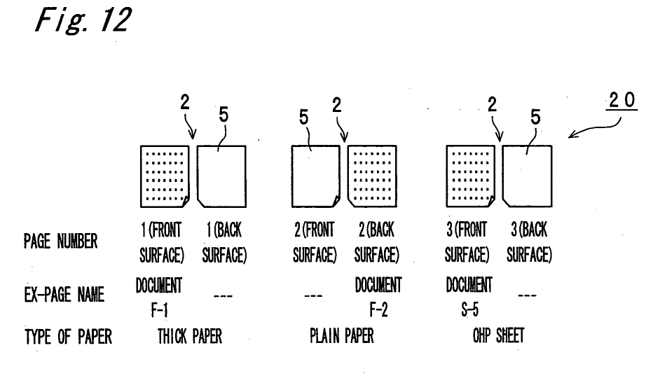

Further, the GUI display section 110 displays an output result, that is, a print preview in image based on the generated print control data 182. In this example, image such as FIG. 12 is displayed.

For example, even when the documents 2 are rearranged or another new document 2 is inserted on the way with respect to the print source document 20 having the aforementioned three documents 2, original print attribute 151 of the each document 2 is not changed while being maintained in the page information database 155, but the sequence of the page names 162 at the page order column 161 in the job ticket 160 is merely changed. Since the print attribute 151 of the each document 2 is certainly referred when generating the print control data 182, the output result is guaranteed by those designated by the print attribute 151. That is, in terms of the aforementioned example, even where the document 2 named the “document F-1” is placed at any position in the print source document 20, printing is performed according to the print attribute 151 set in the document 2 of the “document F-1,” that is, printing is performed according to such setting: a type of paper is thick paper, basis weight is 72 to 91 g/m², page allocation is not available, front surface of double-sided printing, left binding, . . . . Further, this mechanism enables the print control apparatus 101 to control the print sequence 163 by which the each document 2 is actually printed by the printer 13.

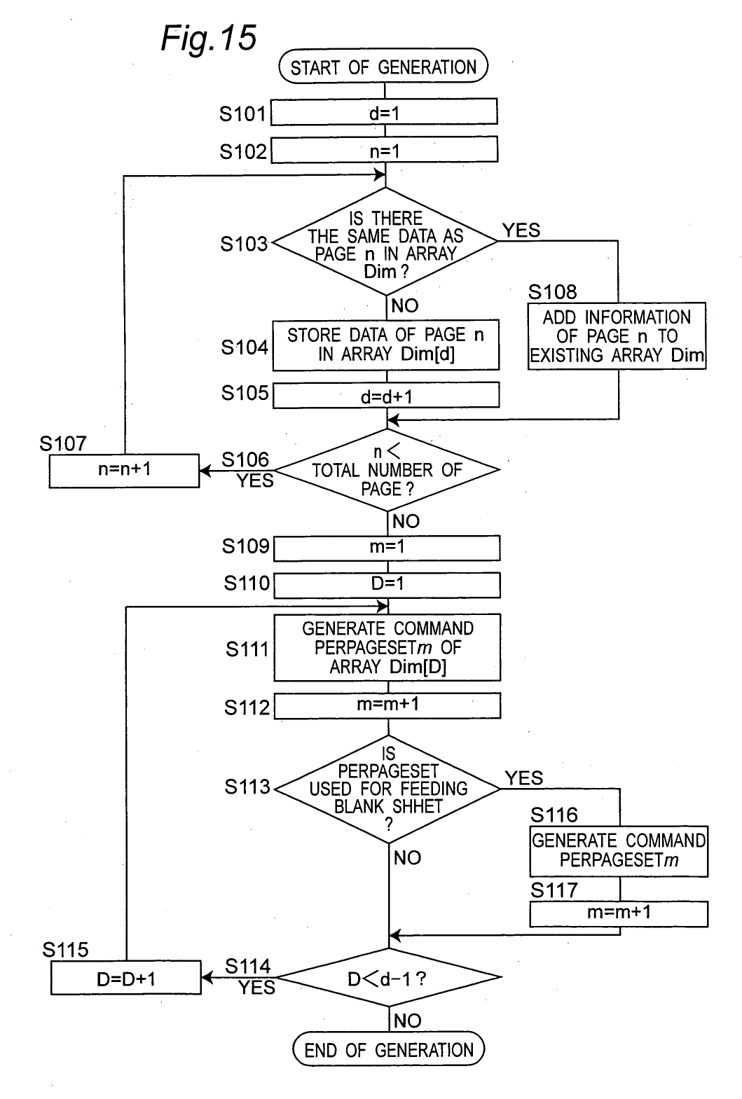

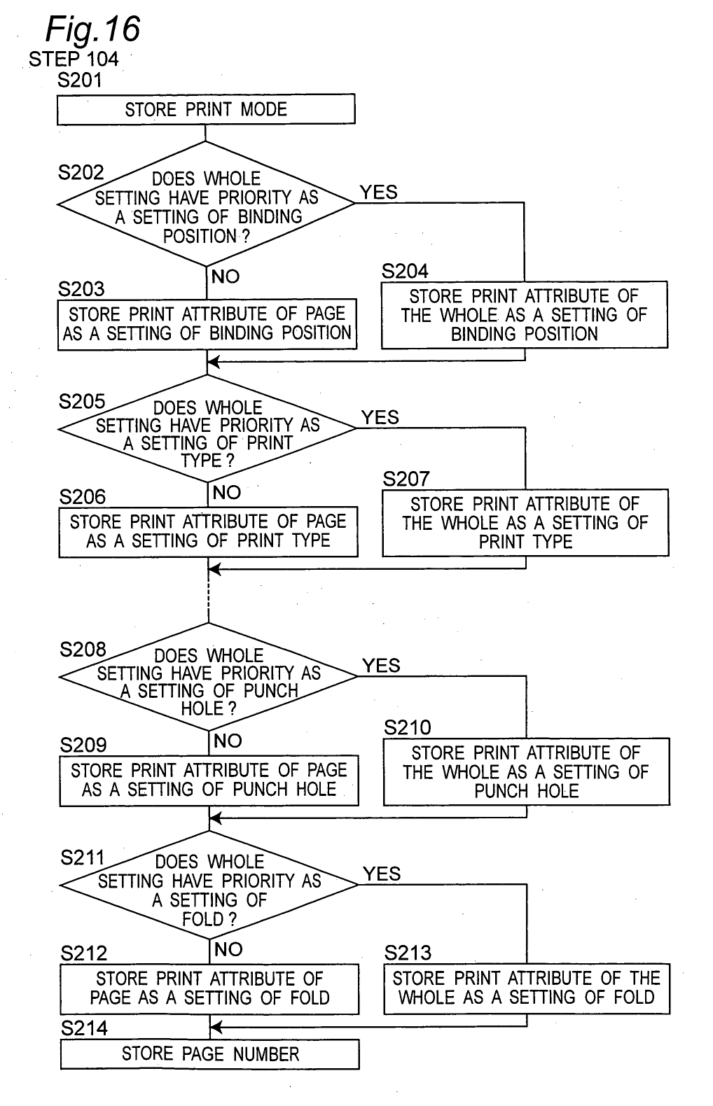

Now, the following description will be made in the case of setting page allocation based on flow charts shown in FIG. 15 and FIG. 16. The description will be made together with the case that the print attribute 151 with respect to the whole print source document 20 has priority over the print attribute 151 of the document 2 and the case that the same print attributes 151 exist in a plurality of documents 2. Further, operation shown in FIG. 15 and FIG. 16 is executed by the print control data generation section 109.

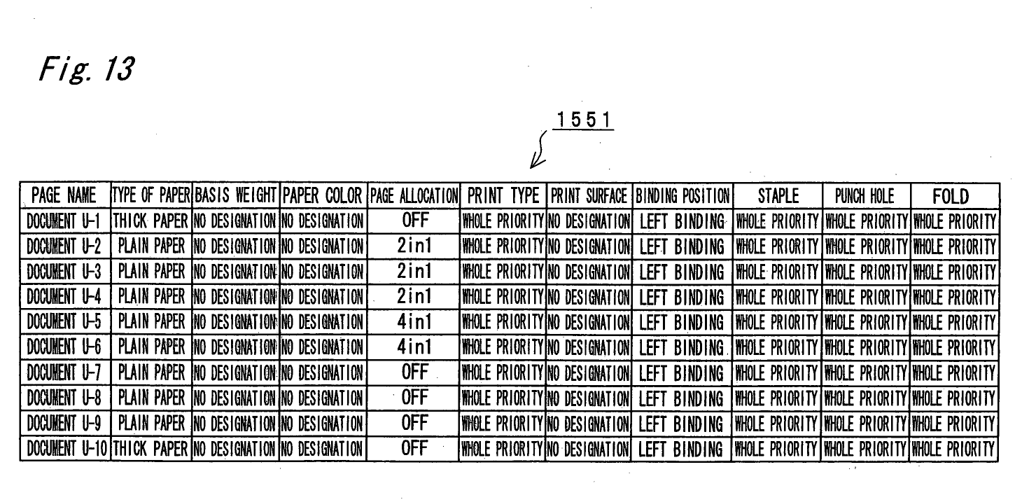

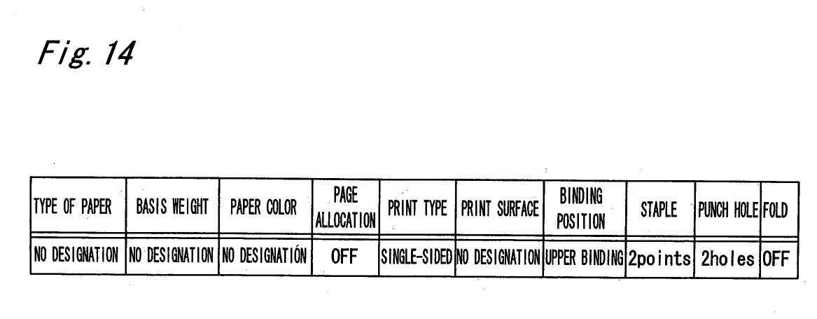

In addition, here, a page information database 1551 shown in FIG. 13 is taken as an example, in order to simplify the description; it is set that the each document 2 of the print source document 20 is disposed in the order from the top to bottom of the page name 162 shown in the page information database 1551. The above page order of the each document 2 is set in the page order column 161 of the job ticket 160 as described above. Further, the print attribute of the whole print source document 20 is set as shown in FIG. 14 and the setting is actually stored in the job ticket 160 which defines the print source document 20. In addition, the print attribute with respect to the whole print source document 20 is stored in the job ticket 160; but, as described above, the print attribute 151 in the each document 2 which constitutes the print source document 20 is stored in the print attribute storage section 106 separately from the job ticket 160. Here, in the print attribute with respect to the whole print source document 20, other than an attribute which does not overlap with the print attribute of the document 2 such as the number of sets, magnification, image quality mode, etc., an attribute which overlaps with the print attribute with respect to the document 2 such as selection of double-sided or single-sided printing, type of paper, etc. can also be set. In this way, when the print attribute with respect to the whole print source document 20 and the print attribute of the document 2 which is the source document configuration part are designated by respective overlapping items and designated by contradicting attribute, the print attribute of the document 2 which is not linked with the print sequence has priority. When the print attribute of the document 2 is not designated, printing is performed by the print attribute with respect to the whole. This enables the printing to be performed while the print attribute designated with respect to the document 2 is maintained even when the print sequence of the document 2 is changed according to designated item of the print attribute with respect to the whole. Further, here, only setting value necessary for description is extracted and it is not limited to the item shown in FIG. 14.

First, in step S101 and step S102, initial values of necessary variables are set. Reference character “d” denotes the number of an array Dim for temporarily singly saving a pattern of the print attribute 151 of the each document 2 included in the print source document 20. The array Dim corresponds to a compilation having the same print attribute on the page information database 155 and 1551 shown in FIG. 10 and FIG. 13; and the array Dim is dynamically held in executing program. Here, the pattern of the print attribute 151 denotes patterns which have each attribute element such as “type of paper,” “basis weight,” . . . , and “fold” shown in FIG. 13 and setting information such as “thick paper,” “no designation,” . . . , and “whole priority”, etc. in the attribute elements. Further, reference character “n” denotes the number of the document 2 which constitutes the print source document 20. The example shown in FIG. 13 is a total of 10 documents 2 of “document U-1” to “document U-10,” and therefore, “n” takes integral value from 1 to 10.

Next, in step S103, it is determined whether or not the print attribute 151 made of the same pattern as the first document 2 (document U-1) is stored in the array Dim. Since it is not stored in the first routine, it is determined as “No” and the flow is advanced to step S104. In step S104, a pattern of the print attribute 151 of the first document 2 is stored in the array Dim [1]. Details of operation in this step S104 is shown in FIG. 16 and will be described below. Further, storing operation to the array Dim in this step S104, that is, operation shown in FIG. 16 is executed by an array holding section 1091 in the print control data generation section 109 shown in FIG. 1.

Setting values of the print attribute 151 are stored in the array Dim in parameter order of arguments based on specifications of the print control command shown in FIG. 11. In step S201, a print mode is stored, that is, it is stored whether the document 2 having image data 150 to be added or the document 2 of blank sheet not having the image data 150 to be added. In step S202, it is determined whether “binding position” is set by using the print attribute 151 of the document 2 or by using the print attribute 151 of the whole print source document 20. In this example, since “left binding” is shown in FIG. 13, the print attribute 151 of the document 2 has priority in the setting of the print attribute 151. Consequently, the flow is advanced to step S203. In step S203, “LEFT” which denotes “left binding” is stored as the setting value of the binding position of Dim “1.” In addition, when the print attribute 151 of the document 2 is “whole priority,” the setting value of “binding position” stored in the job ticket 160 is stored. Specifically, as shown in FIG. 14 for illustrating the print attribute 151 with respect to the whole print source document 20, “upper binding” is stored as the setting value of the binding position.

Although the setting value of “print type” is stored in step S205 to step S207, since “whole priority” is taken as shown in FIG. 13, step S207 is executed here; as shown in FIG. 14, “single-sided” which is the print attribute 151 of the whole print source document 20 is stored as the setting value. Thereafter, in a similar way, determination and storage are repeated up to the setting value of “folding function” in the print attribute 151; page number is stored in step S214. In this routine, “1” is stored.

Turn back to description with reference to FIG. 15 again.

The variable “d” is increased for the next array in step S105. It is determined in step S106 whether or not the document 2 which performed current processing is the last document. Since successive document 2 is remained in this time routine, the flow is advanced to step S107; and the variable “n” is increased for performing process of the next document 2.

Turn back to step S103 again, next, processing of the second document 2 (document U-2) is performed. As shown in FIG. 13, since the print attribute 151 is different between the first document 2 (document U-1) and the second document 2 (document U-2), therefore the flow is passed through the same routine as the previous processing. Then, this time, the setting value with respect to the second document 2 named as “document U-2” is stored in the array Dim [2].

Turn back to step S103 three times, processing of the third document 2 (document U-3) is performed. The same print attribute 151 as the second document 2 is set to the third document 2; and since the same setting is already stored in the Dim [2], the flow is advanced to routine of step S108. Here, of the setting value of the existing Dim [2], current page number “n”, that is, “3” is added to only setting value of the page number.

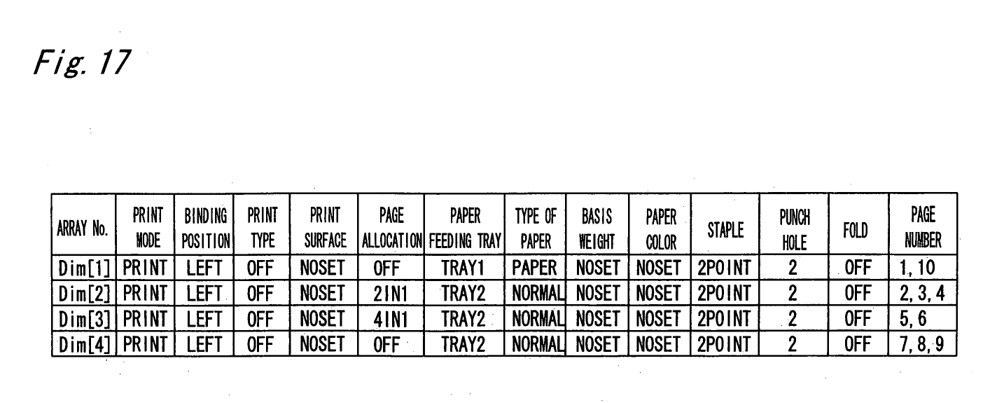

The flow is advanced to step S109 by executing the aforementioned similar operation with respect to for a total of 10 documents 2 of the print source document 20. A storing example of the array Dim formed here is shown in FIG. 17. “TRAY 1” and “TRAY 2” set at a “paper feeding tray” in FIG. 17 denote that the optimum tray is automatically selected in order. This example needs two types of papers for the all documents 2 as a type of paper. Therefore, two types of papers are allocated for the paper feeding trays as the TRAY1 and TRAY2 and are stored in the array Dim. In the unlikely event that the paper feeding tray needs to be allocated more than the number of trays that the printer 13 has, different type of papers are allocated to the same paper feeding tray. In this case, a mechanism performing print by dividing the print source document 20 at the portion where the allocation is overlapped is installed and papers in the tray are replaced on the way every divided print source document 20 when printing, whereby printed result can be maintained as the print attribute 151 is set.

Parameters for actually generating the print control command are initialized in steps S109 and S110. Here, reference character “m” denotes a variable to be entered to # of PERPAGESET# which is the print control command; reference character “D” denotes a variable to be used for sequentially processing the array Dim from the first array Dim.

First, a command PERPAGESET1 for implementing the array Dim [1] is generated in step S111. Variable “m” is increased in the next step S112 to prepare for generating the following command PERPAGESET2. It is determined whether or not the condition for feeding the non-print part, that is, the blank sheet is generated in step S113. In addition, “perpageset” is a command for performing print control of the every document 2; in step S113, it is determined whether or not the function for feeding theblank sheet is implemented by using the command. The case that the blank sheet is fed is as already described. When the command PERPAGESET for the blank sheet needs to be generated, the flow is advanced to steps S116 and S117. On the other hand, when the blank sheet need not be fed, the flow is advanced to step S114.

In addition, determination whether or not the non-print part is fed and generation of the command PERPAGESET for feeding the non-print part are executed by a non-print form section 1092 included in the print control data generation section 109.

It is determined whether or not the all array Dim generated by step S106 prepare the print control command, in step S114. When there is unprocessed array Dim, the flow is returned to step S111 via step S115 to repeat generation routine of the command PERPAGESET. On the other hand, when processing of the all array Dim is completed, the flow is exited from a loop to complete the operation. In this example, the following print control data are generated.

@PJL SET PERPAGESET1=PRINT,LEFT,OFF,NOSET,OFF,TRAY1,PAPER,NOSET,NOSET,2POINT,2, OFF,1,10

@PJL SET PERPAGESET2=PRINT,LEFT,OFF,NOSET,2IN1,TRAY2,NOMAL,NOSET,NOSET,2POINT,2, OFF,2-4

@PJL SET PERPAGESET3=PRINT,LEFT,OFF,NOSET,4IN1,TRAY2,NOMAL,NOSET,NOSET,2POINT,2, OFF,5-6

@PJL SET PERPAGESET4=PRINT,LEFT,OFF,NOSET,OFF,TRAY2,NOMAL,NOSET,NOSET,2POINT,2, OFF,7-9

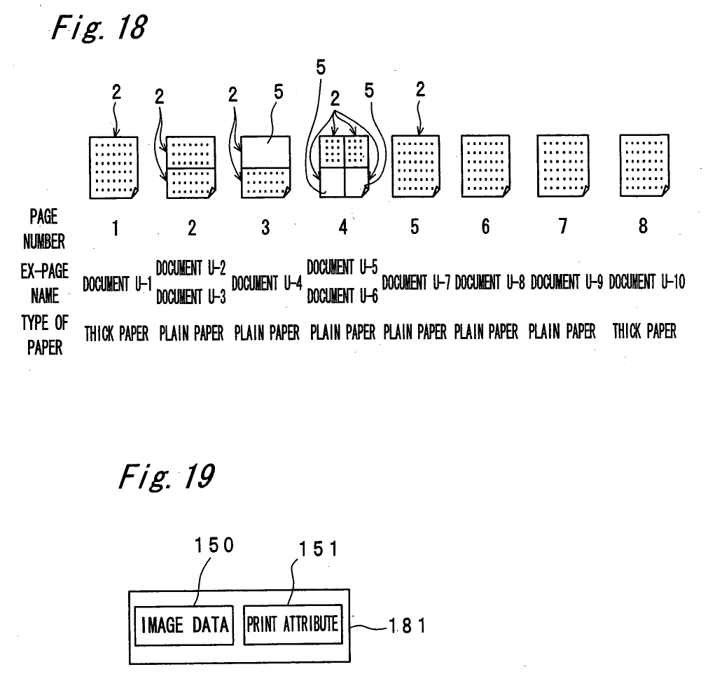

Setting of “2 in 1” as “page allocation” is performed in the second document 2 (document U-2) to the fourth document 2 (document U-4). Consequently, the number of the documents 2 becomes three, but it becomes a layout actually having four documents 2. Further, the print attribute 151 in the fifth document 2 (document U-5) differs from the print attribute 151 in the fourth document 2 (document U-4). Consequently, it is not possible to make a layout with a pair of the fourth document 2 and the fifth document 2. Thus, printing of a portion, which cannot make a layout with a pair, is performed in a state that blank sheet 5 corresponding to a non-print part is fed, that is, the non-print part 5 is formed as shown in FIG. 18. As similar to this case, setting of “4 in 1” is performed in the fifth document 2 (document U-5) and the sixth document 2 (document U-6) as “page allocation;” and consequently, it is possible to make a layout in which the number of the documents 2 becomes four. But, the number is actually two, that is, document 2 (document U-5) and document 2 (document U-6). Thus, printing of a portion, which cannot make a layout with specified four documents, is performed in a state that blank sheet 5 is fed.

The above operations depend on the print control data 182. But, layout processing itself such as “2 in 1” and “4 in 1” may be performed by the print control apparatus 101 or a print control program which is executed by the print control apparatus 101 and determination processing whether or not the blank sheet is fed, whereby the print page order may be controlled.

When the layout of the document 2 and management of the print attribute 151 are implemented by the print control apparatus 101 or the print control program, actual control that which document 2 is printed in a record paper of which page number can be performed by the print control apparatus 101 or the print control program. Consequently, it becomes possible that the GUI display section 110 determines condition that blank sheet 5 is fed, from a control command and a setting of the print attribute 151 to display a print preview indicating a state that the blank sheet is fed. As for the a fore mentioned example, the print preview image shown in FIG. 18 is made.

As described above, according to the source document management method, the print control apparatus, and the print control program, there are the following effects.

In other words, the print sequence of the each source document configuration part does not link with the print attribute set to the each source document configuration part. That is, the source document configuration part with the print attribute, in which the print attribute is set, does not relate to the print sequence information; in other words, the source document configuration part with the print attribute does not have the print sequence information. Consequently, when the print source document is printed, the print sequence information only have to be added with respect to the source document configuration part with the print attribute. Put simply, print control data, in which the print sequence information is added to the source document configuration part with the print attribute, only have to be formed. Therefore, in the print source document, even when the source document edition or the like, for example, rearrangement of the source document configuration part or changing of the combination thereof is performed, the print attribute in the source document configuration part does not change. That is, only the print sequence information in the source document configuration part with the print attribute is changed. Therefore, even when the source document configuration is changed due to source document edition or the like, a user need not reset the print attribute to the source document configuration part again in response to new print sequence. User's desired print, that is, printing the source document configuration part in the print sequence of the source document configuration part by the designated print attribute is made possible.

Further, for example, when the first source document configuration part and the second source document configuration part are continually printed, there is a case that the print attribute such as type of paper, basis weight, and allocation is different between the first source document configuration part and the second source document configuration part. That is, for example, when the source document has 4 pages, the first page is printed on thick paper and the second to the fourth pages are printed on plain paper, and further for example, in the case of designating that for 2 pages are printed in one sheet; conventionally, although the second page is desired to be printed on plain paper, the first page and the second page are printed on one sheet of thick paper and the third page and the fourth page are printed on one sheet of plain paper. On the other hand, according to the source document management method, the print control apparatus, and the print control program of the present embodiment, as described above, the source document configuration part with the print attribute, in which the print attribute is set, does not link with the print sequence information, and the print control data is generated by adding the print sequence information to the source document configuration part with the print attribute; whereby the non-print part, that is, the blank sheet part is automatically formed. In other words, in the above example, the first sheet is thick paper, the first page is printed on its front surface, and the blank sheet part is formed on its back surface; the second page and the third page are printed on plain paper of the second sheet; and the fourth page is printed on plain paper of the third sheet. As described above, user's desired appropriate print control data can be generated at any time.

As described above, since the source document configuration part with the print attribute is not related to the print sequence information, there arises a case that the print source document is required to confirm how it is printed. Consequently, a user can confirm the print sequence of the each source document configuration part and the print attribute in the each source document configuration part before printing by providing the display section and displaying the print preview.

The present invention can be suitably applied to, for example, a source document management method for printing a print source document having a plurality of documents, a print control apparatus for executing the source document management method, and a print control program.

It is to be noted that, by properly combining the arbitrary embodiments of the aforementioned various embodiments, the effects possessed by them can be produced.

Although the present invention has been fully described in connection with the preferred embodiments there of with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A source document management method for managing a print source document having a plurality of source document configuration parts, the method comprising:
setting a print sequence of each of the source document configuration parts in the print source document to a job ticket; and
with respect to each of the source document configuration parts, setting a print attribute of the source document configuration part separately from the job ticket.

2. The source document management method according to claim 1, further comprising, after obtaining the print sequence of the source document configuration part and each print attribute,
generating print control data, which enables a printing apparatus to print each of the source document configuration parts in accordance with the print attribute and the print sequence, when the print source document is printed.

3. The source document management method according to claim 2, further comprising, when generating the print control data, selecting the source document configuration part set in the job ticket and disposed with the print sequence on a basis of a name of the source document configuration part, extracting the print attribute set in the selected source document configuration part, and making the print sequence and the extracted print attribute correspond to each other.

4. The source document management method according to claim 2, further comprising, before printing, displaying a print preview of the source document configuration part on a basis of the generated print control data.

5. The source document management method according to claim 2, further comprising, when generating the print control data, forming a non-print part in the print source document according to the print attribute and the print sequence in the source document configuration part.

6. The source document management method according to claim 1, wherein the setting of the print attribute with respect to the source document configuration part is performed in a state irrelevant to the print sequence.

7. A print control apparatus for controlling print operation of a print source document having a plurality of source document configuration parts, the apparatus comprising:
a job ticket storage section configured to store a job ticket having a print sequence of each of the source document configuration parts;
a print attribute storage section configured to store a print attribute to be set with respect to each of the source document configuration parts; and
a print control data generation section configured to obtain the print sequence and the print attribute of the source document configuration part, and generate print control data which enables a printing apparatus to print the each source document configuration part according to the print attribute and the print sequence.

8. The print control apparatus according to claim 7, further comprising a display section configured to display a print preview of the source document configuration part in graphical user interface display before printing based on the generated print control data.

9. The print control apparatus according to claim 7, further comprising a print attribute setting section configured to set the print attribute every source document configuration part.

10. Theprint control apparatus according to claim 7, wherein the print control data generation section is configured to have a non-print form section configured to form a non-print part in the print source document in accordance with the print attribute and the print sequence in the source document configuration part.

11. The print control apparatus according to claim 7, wherein the print control data generation section is configured to generate the print control data by selecting the source document configuration part set in the job ticket and disposed with the print sequence on a basis of a name of the source document configuration part, extracting the print attribute set in the selected source document configuration part, and making the print sequence and the extracted print attribute correspond to each other.

12. The print control apparatus according to claim 7, wherein the print attribute storage section is configured to store the print attribute in a state irrelevant to the print sequence.

13. A print control program for printing a print source document having a plurality of source document configuration parts, the program making a printing apparatus execute and comprising:
setting a print sequence of each of the source document configuration parts in the print source document to a job ticket;
setting a print attribute of the source document configuration part with respect to the each of the source document configuration parts separately from the job ticket;
obtaining the print sequence and the print attribute of the source document configuration part; and
generating print control data which enables the printing apparatus to print each source document configuration part according to the print attribute and the print sequence.

14. The print control program according to claim 13, wherein the print control data is generated by selecting the source document configuration part set in the job ticket and disposed with the print sequence on a basis of a name of the source document configuration part, extracting the print attribute set in the selected source document configuration part, and making the print sequence and the extracted print attribute correspond to each other.

15. The print control program according to claim 13, further comprising displaying a print preview of the source document configuration part before printing based on the generated print control data.

16. The print control program according to claim 13, wherein in generating the print control data, a non-print part is formed in the print source document according to the print attribute and the print sequence in the source document configuration part.

17. The print control program according to claim 13, wherein the setting of the print attribute with respect to the source document configuration part is performed in a state irrelevant to the print sequence.
